(19) United States
(12) Patent Application Publication
(10) Pub. No.: US 2024/0190072 A1
(43) Pub. Date: Jun. 13, 2024

(54) ADDITIVE MANUFACTURE WITH LINE-SHAPED ENERGY BEAM

(71) Applicant: Hewlett-Packard Development Company, L.P., Spring, TX (US)

(72) Inventor: Seongsik CHANG, Palo Alto, CA (US)

(73) Assignee: Hewlett-Packard Development Company, L.P., Spring, TX (US)

(21) Appl. No.: 18/286,479

(22) PCT Filed: Apr. 12, 2021
(86) PCT No.: PCT/US2021/026868

§ 371 Date: Oct. 11, 2023

(51) Int. Cl. B29C 64/282; B29C 64/165; B29C 64/236; B29C 64/268; B33Y 10/00; B33Y 30/00

(52) U.S. Cl. CPC B29C 64/282; B29C 64/165; B29C 64/236; B29C 64/268; B33Y 10/00; B33Y 30/00

(57) ABSTRACT

In one example in accordance with the present disclosure, an additive manufacturing system is described. The additive manufacturing system includes a build material distributor to deposit layers of powder build material on a bed and an agent distribution system to deposit an agent on a layer of powder build material in a pattern to form a slice of a three-dimensional object. The additive manufacturing system also includes an energy delivery system to generate a line-shaped beam of energy to selectively join build material particles with the agent deposited thereon. The line-shaped beam of energy spans a width of the bed. The additive manufacturing system also includes a scanning carriage to hold the energy delivery system and move the line-shaped beam of energy across the bed.

### BACKGROUND

Additive manufacturing systems produce three-dimensional (3D) objects by building up layers of material. Some additive manufacturing systems use inkjet or other printing technology to apply some of the manufacturing materials. Additive manufacturing systems make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for generating a line-shaped energy beam, according to an example of the principles described herein.

FIG. 2 is an isometric view of an additive manufacturing system for generating a line-shaped energy beam, according to an example of the principles described herein.

FIG. 3 is a top view of an additive manufacturing system with a line-shaped energy beam, according to an example of the principles described herein.

FIG. 4 is a flow chart of a method for additive manufacturing using line-shaped energy beam, according to an example of the principles described herein.

FIG. 5 is a front view of an additive manufacturing system with a line-shaped energy beam, according to an example of the principles described herein.

FIG. 6 is a front view of another additive manufacturing system with a line-shaped energy beam, according to an example of the principles described herein.

FIG. 7 is a front view of generating a line-shaped energy beam from a light-emitting diode (LED) array, according to an example of the principles described herein.

FIG. 8 is a flow chart of a method for generating a line-shaped energy beam during additive manufacturing, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided design (CAD) computer program product. The model data is processed into slices, each slice defining portions of a layer of build material that are to be solidified.

In one particular example, a powder build material is deposited and a binding agent is selectively applied to the layer of powder build material. The binding agent is deposited in a pattern of a slice of a 3D object to be printed. This process is repeated per layer until the 3D object is formed. Such a binding-agent-based system may be used to generate metallic or ceramic 3D objects.

With a 3D object formed, the binding agent is cured to form a “green” 3D object. Cured binding agent holds the build material of the green object together. The binding agent may include a binding component. The binding component in the binding agent is activated or cured by heating the binding agent to about the melting point of the solvent in the binding agent. When activated or cured, the binding component glues the powder build material particles into the cured green object shape. The cured green object has enough mechanical strength such that it is able to withstand extraction from the build material platform without being deleteriously affected (e.g., the shape is not lost). This process is repeated in a layer-wise fashion to generate a green 3D object.

The green 3D object may then be placed in an oven to expose the green 3D object to electromagnetic radiation and/or heat to sinter the build material in the green 3D object to form the finished 3D object. Specifically, the binding agent is removed and the temperature is further raised such that sintering of the powder metal particles occurs to form a 3D object.

While in the oven, further heating is applied to sinter the 3D object wherein the already partially melted build material is further solidified to increase its densification to at least about 95 percent densification, in some examples. In some examples, such as when the build material comprises a metal powder material, such sintering temperatures may range between about 900 degrees Celsius to about 1700 degrees Celsius. It is to be understood that the term “green” does not connote color, but rather indicates that the part is not yet fully processed.

In another example, to form a 3D object out of plastic material, a build material, which may be powder, is deposited on a bed. A fusing agent is then dispensed onto portions of a layer of build material that are to be fused to form a layer of the 3D object. The system that carries out this type of additive manufacturing may be referred to as a powder and fusing agent-based system. The fusing agent disposed in the desired pattern increases the energy absorption of the layer of build material on which the agent is disposed. The build material is then exposed to energy such as electromagnetic radiation. The electromagnetic radiation may include infrared light, ultraviolet light, laser light, or other suitable electromagnetic radiation. Due to the increased heat absorption imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has increased energy absorption, fuses while that portion of the build material that has not received the fusing agent remains in powder form. Those portions of the build material that receive the agent and thus have increased heat absorption may be referred to as fused portions. By comparison, the applied heat does not increase the temperature of the portions of the build material that are free of the agent to this fusing temperature. Those portions of the build material that do not receive the agent and thus do not have increased heat absorption may be referred to as unfused portions.

Accordingly, a predetermined amount of heat is applied to an entire bed of build material, the portions of the build material that receive the fusing agent, due to the increased heat absorption imparted by the fusing agent, fuse and form the object while the unfused portions of the build material are unaffected, i.e., not fused, in the presence of such application of thermal energy. This process is repeated in a layer-wise fashion to generate a 3D object. The unfused portions of material can then be separated from the fused portions, and the unfused portions recycled for subsequent 3D formation operations.

While such additive manufacturing operations have greatly expanded manufacturing and development possibilities, further development may make additive manufacturing a part of even more industries. For example, in additive manufacturing, energy is delivered to join, i.e., fuse or bind, powder build material particles together. Energy may be delivered in the form of light. For example, with plastic multi-jet fusion, a lamp may be used to deliver the energy. As another example, in a binder jet system a curing lamp may be used to cure the binder, that is to evaporate solvent of jetted binder. In yet another example, a flash lamp may be used to partially melt metal powders. However, each energy delivery system may have certain inefficiencies.

For example, in a binder jet system, a solvent of the jetted binding agent may remain uncured in the powder bed. As the binding agent is not cured, the 3D object may be soft and may be damaged upon removal from the powder bed. Moreover, voxels with uncured binding agent disposed thereon may be susceptible to damage, for example during the spread of a subsequent layer of build material. That is, while fused build material does not move when a subsequent layer of build material is deposited and re-coated, unfused build material, not having a fusing agent deposited thereon, may be moved around during the build material deposition operation. In particular when a subsequent layer of build material is re-distributed, for example by a roller, and a shear pressure is applied by the subsequent material. Accordingly, build material with uncured binding agent may be moved as a next layer is being deposited and re-distributed.

As another example, when the build material is a polymer and the energy source is a halogen lamp, the exposure time used to fuse the build material may be between 50 milliseconds (msec) and 200 msec, which may cause heat loss due to the long exposure time. For example, the heat applied via a halogen lamp, or any other source may exhibit conductive heat loss through the build material, convective heat loss through ambient air, and radiative heat loss. Such heat loss may be present in other forms of additive manufacturing as well, such as binding agent-based systems. However, due to the long exposure times in polymer fusing, such heat losses may be particularly prevalent.

Accordingly, the present specification addresses these and other issues by reducing the overall exposure time which may result in more efficient heating without re-heating previous layers or losing heat to other surrounding medium. Specifically, the present specification, describes an additive manufacturing system that includes an energy delivery system that includes an energy source such as a laser or light emitting diode (LED) array to generate energy. A lens, or other component, receives the energy from the laser and reshapes it into a generally line-shaped beam spanning at least a portion of the powder bed. The additive manufacturing system may move the energy source and/or lens to sweep the line-shaped beam of energy along the powder bed and fuse or bind the powder build material particles with agent disposed thereon.

Such a system provides for short duration illumination with an exposure time in the milliseconds range. The short duration illumination may be highly focused thus providing energy sufficient to bind/fuse all while reducing energy loss during illumination. In this example, a width of focused line-shape energy beam determines an intensity and exposure duration. The additive manufacturing system as presented in the present specification may be a polymer multi-jet fusion agent-based system, a metal binding agent-based system, or a plastic binding agent-based system, among others.

Specifically, the present specification describes an additive manufacturing system. The additive manufacturing system includes a build material distributor to deposit layers of powder build material on a bed and an agent distribution system to deposit an agent on a layer of powder build material in a pattern to form a slice of a three-dimensional object. The additive manufacturing system also includes an energy delivery system to generate a line-shaped beam of energy to selectively join build material particles with the agent deposited thereon. The line-shaped beam of energy may span a width of the bed. The additive manufacturing system also includes a scanning carriage to hold the energy delivery system and move the line-shaped beam of energy across the bed.

The present specification also describes a method of generating a line-shaped beam of energy. According to the method, a layer of build material is deposited on a bed and an agent is deposited across the layer of build material. The agent is deposited in a pattern to form a slice of a three-dimensional object. A line-shaped energy beam is generated to span a width of the bed and is scanned across the bed to selectively join build material particles with agent deposited thereon.

The present specification also describes another example of an additive manufacturing system. In this example, the additive manufacturing system includes the build material distributor and the agent distribution system. Further in this example, the energy delivery system includes an array of lasers, a collimating lens per laser connected via a fiber-optic cable to a respective laser, and a Powell lens per collimating lens to alter a shape of an incoming circular energy beam to a line-shaped energy beam to span a width of the bed. In this example, the additive manufacturing system includes the scanning carriage and the collimating lens and Powell lens are disposed on the scanning carriage.

As compared to other systems which may have a fixed beam size such that exposure time is fixed, the present additive manufacturing system uses a moveable energy source and a relay optic or telescopic beam expander to vary the beam width. Such a system may have exposure times of between 0.1 msec-10msec and have an intensity of 150-1500 watts per cubic centimeter (W/cm²). These values may be achieved by tuning the laser beam linewidth from 25 micrometers (um) to 2.5 millimeters (mm).

Moreover, by using a focused energy source rather than a more general bed-wide energy source, the present additive manufacturing system may provide for more efficient heating. That is, heating the powder bed with a short light pulse may reduce heat loss by conduction, convection, and radiation. Specifically, the short exposure time resultant from moving the energy source across the surface may cause the energy to penetrate to a shallow depth, and therefore prevent unnecessary energy delivery to deeper locations of the powder bed.

Accordingly, such systems and methods 1) provide a layer-by-layer curing of a binding agent; 2) provide energy sources that are energy efficient; 3) avoids use of a back reflecting mirror; 4) is compact; 5) reduces heat losses through conduction, convection, and radiation; 6) reduces the heating time such that the whole additive manufacturing operation is more efficient; and 7) Focuses the energy to reduce exposure time.

As used in the present specification and in the appended claims, the term “join” refer to any fusing, binding, melting, or sintering of raw metal powder build material that eventually transform into a solid portion of a 3D object.

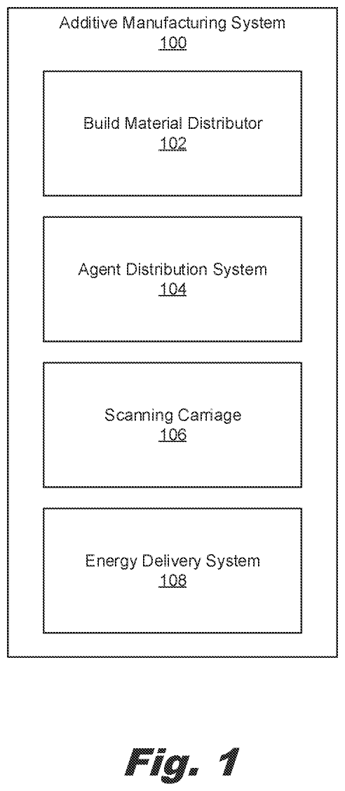

Turning now to the figures, FIG. 1 is a block diagram of an additive manufacturing system (100) for generating a line-shaped energy beam, according to an example of the principles described herein. The additive manufacturing system (100) may include a build material distributor (102) to deposit layers of powder build material on a bed. This powder build material may be the raw material from which a 3D object is formed. That is, portions of the powder build material that are joined together form a solid structure. The powder build material may be of a variety of types. For example, the build material may be a metal material, such as a metal powder. The metal powder build material may include metallic particles such as steel, bronze, titanium, aluminum, nickel, cobalt, iron, nickel cobalt, gold, silver, platinum, copper and alloys of the aforementioned metals. While several example metals are mentioned, other alloy build materials may be used in accordance with the principles discussed herein.

In some examples, the build material may be a ceramic material, while in other examples the build material may comprise a crystal material. Some specific example materials may comprise quartz, alumina, glass, and the like.

In some examples, the build material may comprise a polymer material. For example, the polymer material may be a polyamide material. While specific reference is made to a polyamide material, the polymer material may be of other types including nylon, thermoplastic materials, resin, carbon-fiber enhanced resin, polyetheretherketone (PEEK), and the like.

The additive manufacturing system (100) also includes an agent distribution system (104) to deposit an agent on a layer of powder build material in a pattern to form a slice of a three-dimensional object. For example, if a 3D object to be formed is a cube, the agent distribution system (104) may deposit the agent in a square pattern to form a square slice of the 3D cube.

In one example, the agent may be a binding agent. That is, the binding agent may include a binding component that when cured, glues the build material particles together during transport to a sintering oven where the 3D object is completely formed. In this example, the energy delivery system (108) cures the binding agent to remove the solvent from the binding agent.

In another example, the agent is a fusing agent. In this example, the energy delivery system (108) is to melt build material particles with fusing agent deposited thereon.

In either example, the agent distribution system (104) may include at least one liquid ejection device to distribute the agent onto the layers of build material. A liquid ejection device may include at least one printhead (e.g., a thermal ejection based printhead, a piezoelectric ejection based printhead, etc.). In some examples, the agent distribution system (104) is coupled to a scanning carriage, and the scanning carriage moves along a scanning axis over the bed. In one example, printheads that are used in inkjet printing devices may be used in the agent distribution devices. In other examples, the agent distribution system (104) may include other types of liquid ejection devices that selectively eject small volumes of liquid.

The additive manufacturing system (100) also includes an energy delivery system (108). The energy delivery system (108) generates a line-shaped beam of energy that selectively joins (i.e., fuses or binds) build material particles with the agent disposed thereon. That is, as described above, in either a fusing agent-based system or a binding agent-based system, energy joins the build material particles together. In a fusing agent-based system, the energy delivery system fuses build material particles together into the final 3D object. In a binding agent-based system, the energy delivery system (108) glues build material particles together to form a green 3D object which is then transported to a sintering oven for forming the final 3D object.

As described above, the line-shaped beam of energy provides focused energy at a desired intensity to the slice of build material. That is, in fusing systems where a halogen lamp is used, the light is radiated across an entire length of the bed. However, the large width of the light exposure on the powder bed by the halogen lamp may result in long exposure times and energy losses. Moreover, in a binding system, there may not be a layer-wise curing process. As such, each layer of the 3D object may include uncured binding agent. In an uncured state, the green 3D object may be weak and the layers of uncured build material may be susceptible to damage as a subsequent layer is deposited.

Accordingly, in the present specification a line-shaped beam of energy is scanned across the bed for each layer of build material to cure or fuse the build material. The line-shaped beam of energy provides focused energy such that shorter exposure times may be used. In such an example, the line-shaped beam of energy may span a length of the bed such that all areas of the bed may fall under the influence of the energy source.

The line-shaped beam of energy may be generated in any number of ways. For example, the energy delivery system (108) may include an array of lasers and a collimating lens per laser connected via a fiber-optic cable to a respective laser. In this example, the energy delivery system (108) may include a Powell lens per collimating lens to alter a shape of an incoming circular energy beam to a line-shaped energy beam. The line-shaped beams of energy per laser combine to span a length of the bed. That is, a Powell lens, can generate a straight uniform laser by fanning out collimated beams in a one direction. A Powell lens may be a round prism with a chevron-shaped roof line. A Powell lens may be formed out of glass or other transparent material, such as a clear plastic.

As another example, the energy delivery system may include a rectangular aperture to block some of the emitted energy. For example, an LED array may diffuse light out in multiple directions, and a stopper or aperture, may be used to shape the emitted light into a line shape. As yet another example, a cylindrical lens may be used to focus the energy in a single direction while allowing the light to fan out in a second direction such that the beam pattern is elliptical. In this example, an aperture or stopper may be used to shape the elliptical light into a line-shaped energy beam.

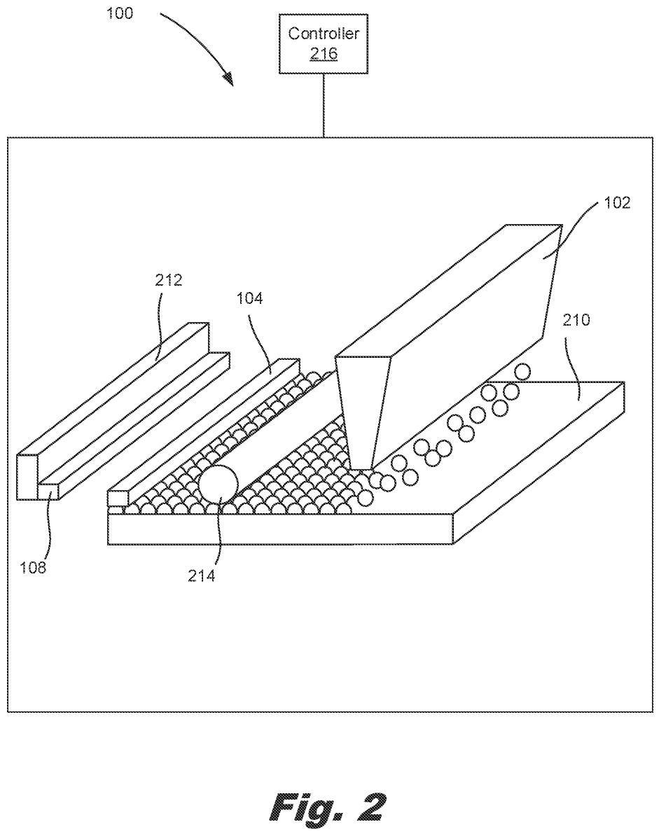

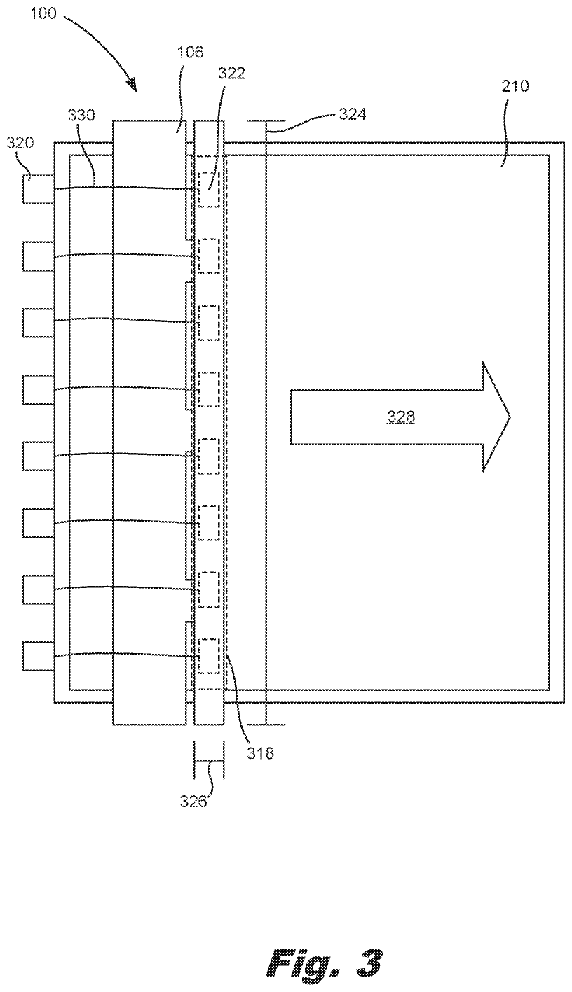

The additive manufacturing system (100) may also include a scanning carriage (106) to hold at least a portion of the energy delivery system (108) and move the line-shaped beam of energy across the bed. That is, the scanning carriage (106) may include a rod along which a carriage traverses across the bed. In the example where the energy delivery system includes an array of lasers, a collimating lens per laser, and a Powell lens per laser, the collimating lenses and the Powell lenses may be disposed on the scanning carriage (106) while the lasers are off-carriage. An example of such a scanning carriage (106) is depicted in FIGS. 2 and 3 below.

In an example, the scanning carriage (106) to which the energy delivery system (108) is coupled may be a build material distributor carriage, an agent distribution system carriage, or a carriage that is independent of either the build material distributor carriage and the agent distribution carriage. That is, the build material distributor (102) and/or the agent distribution system (104) may be coupled to different carriages and the energy delivery system (108) may be coupled to either of these or a separate carriage.

Accordingly, rather than a stationary energy source, the present additive manufacturing system includes a translating energy source. Doing so provides for a focused beam of energy that is localized to a particular region of the bed, rather than a generalized energy that is distributed across the entire surface of the bed.

FIG. 2 is an isometric view of an additive manufacturing system (100) for generating a line-shaped energy beam, according to an example of the principles described herein. Components of the additive manufacturing system (100) depicted in FIG. 2 may not be drawn to scale and thus, the additive manufacturing system (100) may have a different size and/or configuration other than as shown therein.

In an example of an additive manufacturing process, a layer of build material may be deposited onto a bed (210). That is, a build material distributor (102) may drop powder build material onto the bed (210). The build material distributor (102) is arranged to dispense a build material layer-by-layer onto the bed (210) to additively form the 3D object. A re-distributor (214) or other mechanism may precisely redistribute (or recoat) the deposited powder build material into a layer of a desired thickness. While FIG. 2 depicts a particular example of a re-distributor (214), other examples of a mechanism to redistribute (or recoat) the deposited powder build material may include a doctor blade or ultrasonic blade.

While FIG. 2 depicts a particular build material distributor (102), the build material distributor (102) may include a variety of devices such as a sieve or rotating slotted rod to roughly dispense the build material. Moreover, while FIG. 2 depicts a particular re-distributor (214), the build material re-distributor (214) may be implemented via a variety of electromechanical or mechanical mechanisms, such as doctor blades, rollers, slot dies, extruders, and/or other structures suitable to spread, deposit, and/or otherwise form a coating of the build material in a generally uniform layer relative to the bed (210) or relative to a previously deposited layer of build material.

In some examples, the build material distributor (102) has a length at least as long as a length of the bed (210), such that the build material distributor (102) can coat the entire bed (210) with a layer of build material in a single pass.

FIG. 2 also clearly depicts an agent distribution system (104) to deposit an agent, such as a fusing agent or a binding agent onto the powder build material.

In some examples, these components, i.e., the build material distributor (102), re-distributor (214), and agent distribution system (104), may be coupled to scanning carriages. During additive manufacturing, these components operate as the scanning carriages to which they are coupled move over the bed (210) along the scanning axis. FIG. 2 also depicts a separate carriage (212). While FIG. 2 depicts the energy delivery system (108) being coupled to the separate carriage (212), any of these carriages may be the scanning carriage (FIG. 1, 106) that holds the energy delivery system (108) components.

In some examples, the bed (210) may be moved up and down, e.g., along the z-axis, so that powder build material may be delivered to the bed (210) or to a previously formed layer of powder build material. For each subsequent layer of powder build material to be delivered, the bed (210) may be lowered so that the build material distributor (102) and re-distributor (214) can operate to place additional powder build material particles onto the bed (210).

Each of the previously described physical elements may be operatively connected to a controller (216) which controls the additive manufacturing. Specifically, in an agent-based system, the controller (216) may direct a build material distributor (102) and any associated scanning carriages to move to add a layer of powder build material. Further, the controller (216) may send instructions to direct a printhead of an agent distribution system (104) to selectively deposit the agent(s) onto the surface of a layer of the build material. The controller (216) may also direct the printhead to eject the agent(s) at specific locations to form a 3D printed object slice.

The controller (216) may include various hardware components, which may include a processor and memory. The processor may include the hardware architecture to retrieve executable code from the memory and execute the executable code. As specific examples, the controller (216) as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (216) cause the controller (216) to implement at least the functionality of building a 3D printed object.

FIG. 3 is a top view of an additive manufacturing system (100) for generating a line-shaped energy beam (318), according to an example of the principles described herein. In the example depicted in FIG. 3, portions of the energy delivery system (FIG. 1, 108) may be coupled to a scanning carriage (106) which moves in a direction indicated by the arrow (328). As depicted in FIG. 3, the line-shaped energy beam (318) may have a length, L, (324) and a width, w, (326).

In one example, the energy delivery system (FIG. 1, 108) may include multiple energy-emitting components, which may be lasers (320) to generate the line-shaped energy beam (318). Each laser (320) generates a line-shaped energy beam segment such that a combined output of each laser (320), after passing through a collimating lens and Powell lens, forms a line-shaped energy beam (318) that spans a length of the bed.

In an example, a laser (320) that emits at a 1 micrometer wavelength may provide more than 100 watts (W) of power. In some examples, an absorbing dye may be ejected to enhance light absorption.

The energy delivery system (FIG. 1, 108) may include various components per laser (320). For example, each laser (320) may be coupled to a fiber optic cable (330) and then to a collimating lens. The energy delivery system (FIG. 1, 108) also includes a Powell lens per laser (320). In FIG. 3, the collimating lens and Powell lens pair is indicated collectively as (322).

In this example, the collimating lens and the Powell lens may be disposed on the scanning carriage (106), while the laser (320), or other energy-emitting element is separated from the scanning carriage (106). Note that for simplicity in FIG. 3, a single instance of a laser (320), fiber optic cable (330), and collimating lens/Powell lens pair (322) are indicated with a reference number. In FIG. 3, the collimating lens/Powell lens pair (322) is indicated in dashed lines to indicate its position internal to the scanning carriage (106).

Binding agent curing or fusing agent melting occurs at a particular fluence, F, or energy per area, which has a unit of measurement of Joules per square centimeter (J/cm²). For binding agent curing, the target fluence for curing may be determined from the energy that can raise the temperature to a value that will evaporate liquids such as water and solvents. An example fluence value for a binding agent system may be 1.5 J/cm².

In a fusing agent-based system, an example fluence for fusing an 80-micrometer layer of polyamide-12 polymer from a bed temperature of 150 degrees Celsius to a melting temperature of around 180 degrees Celsius may be 0.5 J/cm². For comparison, a halogen lamp may provide fluence of greater than 5 J/cm². Similar fluence values may be calculated for curing a metal nanoparticle binding agent and a metal salt binding agent. In general, the speed of the scanning carriage (106) in the direction indicate by the arrow (328) may define how much energy per second, i.e., power, should be applied to cure or fuse the agent.

As the area coverage is a length, L, (324) times speed of the scanning carriage (106), v, the power to cure or fuse is given by:

P=F·v·L

For example, if Fis 1.5 J/cm², v is 25 centimeters per second (cm/sec), and L is 45 cm, the power, P, that should be delivered by the energy delivery system (FIG. 1, 108) is determined to be 1.7 kilowatt (KW). Accordingly, an appropriate laser (320) with a target power may be selected.

In an example, the exposure time of the powder bed (210) may be determined by:

$${T}_{exp} = \frac{w}{v}$$

Accordingly, when v is 25 cm/sec and a width, w, (326) of the line-shaped energy beam (318) is 100 um, then the exposure time, Tₑₓₚ, may be 0.4 msec. By comparison, when v is 25 cm/sec, w is 1 millimeter, then Tₑₓₚ, may be 4 msec. A light intensity of the line-shaped energy beam may be given by:

$$I = \frac{P}{A} = \frac{P}{L w}$$

For example, when P is 1.7 KW, L is 45 cm, and w is 100 um, the light intensity, l, may be 3.8 kW/cm². When w is 1 mm, l may be 380 W/cm². As noted above, the intensity and exposure time may be adjusted by adjusting a width (326) of the line-shaped energy beam (318). The ability to tune the exposure time and light intensity provides for a versatility and customization of the energy delivery system (FIG. 1, 108) based on any number of characteristics of the binding agent, fusing agent, and/or additive manufacturing system (FIG. 1, 100).

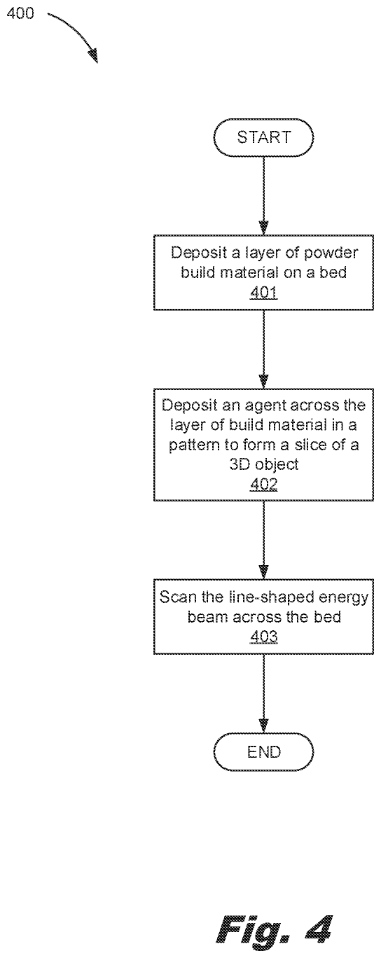

FIG. 4 is a flow chart of a method (400) for additive manufacturing using a line shaped energy beam, according to an example of the principles described herein. As described above, additive manufacturing involves the layer-wise deposition of build material and curing or fusing certain portions of a layer to form a slice of a 3D object. Accordingly, in this example, the method (400) includes sequentially forming slices of a 3D object. In some examples, this includes sequentially depositing (block 401) layers of a powder build material and depositing (block 402) an agent across the layer of build material in a pattern to form a slice of a 3D object. As described above, the agent may be a binding agent to glue build material particles together or may be a fusing agent to melt plastic build material particles together. These deposition operations may include sequential activation, per slice, of a build material distributor (FIG. 1,102) and an agent distribution system (FIG. 1, 104) and the scanning carriages to which they may be coupled so that each distributes a respective composition across the surface.

The method (400) also includes scanning (block 403) a line-shaped energy beam (FIG. 3, 318) across the bed (FIG. 2, 210) to selectively join build material particles with agent deposited thereon. As described above, an energy delivery system (FIG. 1, 108) that generates such a line-shaped energy beam (FIG. 3, 318) may take many forms including lasers (FIG. 3, 320) and lenses to direct and shape an output of the laser (FIG. 3, 320) into a line-shaped energy beam (FIG. 3, 318), which line-shaped energy beam (FIG. 3, 318) provides focused and localized fusing or gluing of build material particles. That is, the line-shaped energy beam (FIG. 3, 318) provides localized energy delivery, and the scanning carriage (FIG. 1, 106) to which components of the energy delivery system (FIG. 1, 106) are coupled, moves this localized energy across the bed (FIG. 2, 210) such that the respective agents absorb the energy to join build material particles with agent deposited thereon.

As described above, these operations (blocks 401, 402, 403) may be repeated to iteratively build up multiple patterned layers and to form the 3D object. For example, the controller (FIG. 2, 216) may execute instructions to cause the bed (FIG. 2, 210) to be lowered to enable the next layer of powder build material to be spread. In addition, following the lowering of the bed (FIG. 2, 210), the controller (FIG. 2, 216) may 1) control the build material distributor (FIG. 1, 102) to form another layer of powder build material particles on top of the previously formed layer and 2) control the agent distribution system (FIG. 1, 104) to selectively deposit agent to form another slice of the 3D object.

Following the deposition of the agent, the controller (FIG. 2, 216) may control the energy delivery system (FIG. 1, 108) and scanning carriage (FIG. 1, 106) to scan a focused line-shaped energy beam (FIG. 3, 318) across the surface of the bed (FIG. 2, 210) to cure or bind the layer of build material to form a hardened slice of the 3D object.

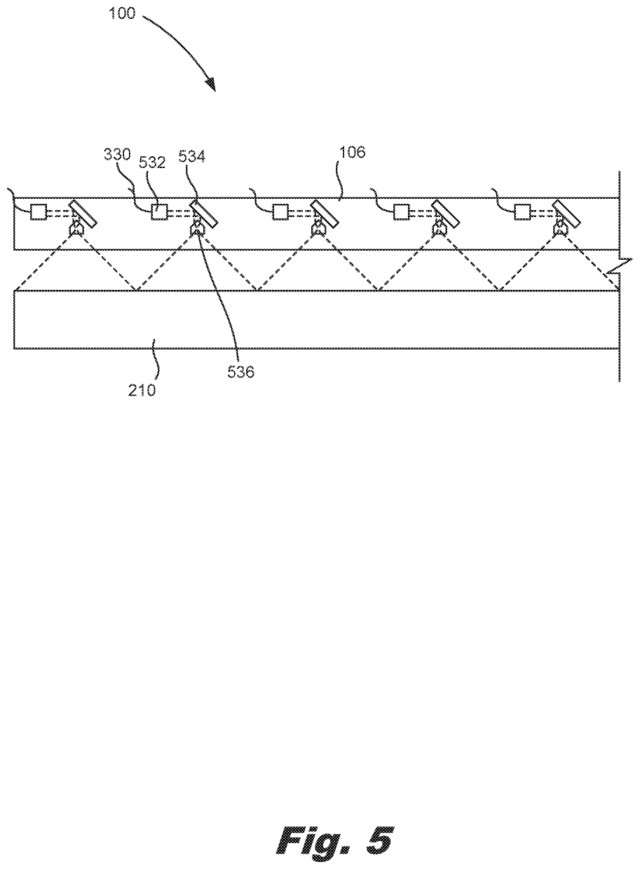

FIG. 5 is a front view of an additive manufacturing system (100) for generating a line-shaped energy beam (FIG. 3, 318), according to an example of the principles described herein. As described above, various components of the energy delivery system (FIG. 1, 108) may be housed on the scanning carriage (106). For example, the additive manufacturing system (100) may include various energy-emitting elements, which may be lasers (FIG. 3, 320) and may be housed off-carriage. However, for certain lasers (FIG. 3, 320), such as semiconductor lasers, the output may be a circular beam. Accordingly, the energy delivery system (FIG. 1, 108) may include various components to adjust and re-direct the laser beam onto the bed (210) as a line-shaped energy beam (FIG. 3, 318).

Specifically, the energy delivery system (FIG. 1, 108) may include a laser (FIG. 3, 320), a fiber-optic cable (330), and a collimating lens (532). That is, as the laser (FIG. 3, 320) may be fiber pig-tailed and a collimating lens (532) may be attached at the end of fiber-optic cable (330), the collimating lens (532) and Powell lens (536) may be placed near the powder bed (210) while the actual diode laser (FIG. 3, 320) may sit somewhere else, such as off of the scanning carriage (106).

The collimating lens (532) may be used to align the output of the laser (FIG. 3, 320). The collimating lens (532) is used to align and focus the output to infinity. As noted above, an exposure time and intensity of the line-shaped energy beam (FIG. 3, 318) may be adjusted by adjusting the width, of the line-shaped energy beam (FIG. 3, 318). In this example, the width of the line-shaped energy beam (FIG. 3, 318) may be adjusted by adjusting the collimating lens (532). For example, the collimating lens (532) may be in a beam expander configuration according to telescopic optics arrangement to adjust a diameter of the output of the laser (FIG. 3, 320). In the beam expander configuration, the diameter of the output of the laser (FIG. 3, 320) may be adjusted by operations such as twisting or adjusting an expander tube. A narrower diameter of a circular laser (FIG. 3, 320) output beam may result in a smaller width of a line-shaped energy beam (FIG. 3, 318).

As described above, the energy delivery system (FIG. 1, 108) may also include a Powell lens (536) to fan out the energy beam to generate the line-shaped beam of energy (FIG. 3, 318). As described above, a Powell lens (536) is a circular lens that has a curved or chevron-shaped roof lens that fans out a circular beam into a linear shaped energy beam. In an example, a Powell lens (536) with a fan angle of 75° may be used and placed 2.3 cm from the bed (210) surface. In this example, the output of a single laser (FIG. 3, 320) is a 3.5 cm long energy beam formed along the length (FIG. 3, 324) of the bed (210). The multiple laser (FIG. 3, 320) outputs may be juxtaposed to form the line-shaped energy beam (FIG. 3, 318) that spans the width of the bed (210) as depicted in FIG. 5. In such an example a distance from the collimating lens (532) to the bed (210) may be around 4 centimeters.

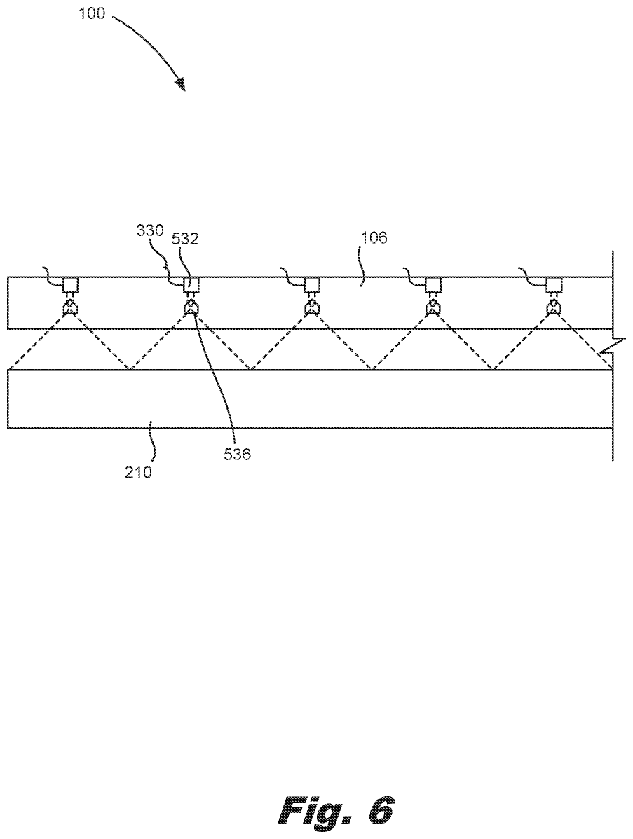

In the example depicted in FIG. 5, the collimating lens (532) is horizontal and the Powell lens (536) is vertical. In this example, the energy delivery system (FIG. 1, 108) may include a mirror (534) between the collimating lens (532) and the Powell lens (536) to alter an angle of the output of the laser (FIG. 3, 320). In this example, the mirror (534) may have a 45-degree angle such that the output of the laser (FIG. 3, 320) is bent by 90 degrees. Note that for simplicity in FIGS. 5 and 6, one instance of multiple components is indicated with a reference number.

FIG. 6 is a front view of an additive manufacturing system (100) for generating a line-shaped energy beam (FIG. 3, 318), according to an example of the principles described herein. As with FIG. 5, FIG. 6 depicts the additive manufacturing system (100) that includes a collimating lens (532) coupled to a laser (FIG. 3, 320) via a fiber-optic cable (330) and a Powell lens (536) to fan out the beam into a line-shaped energy beam (FIG. 3, 318). In this example, the collimating lens (532) is vertical as is the Powell lens (536), such that there is no mirror to alter an angle of the output of the laser (FIG. 3, 320) towards the bed (210) surface.

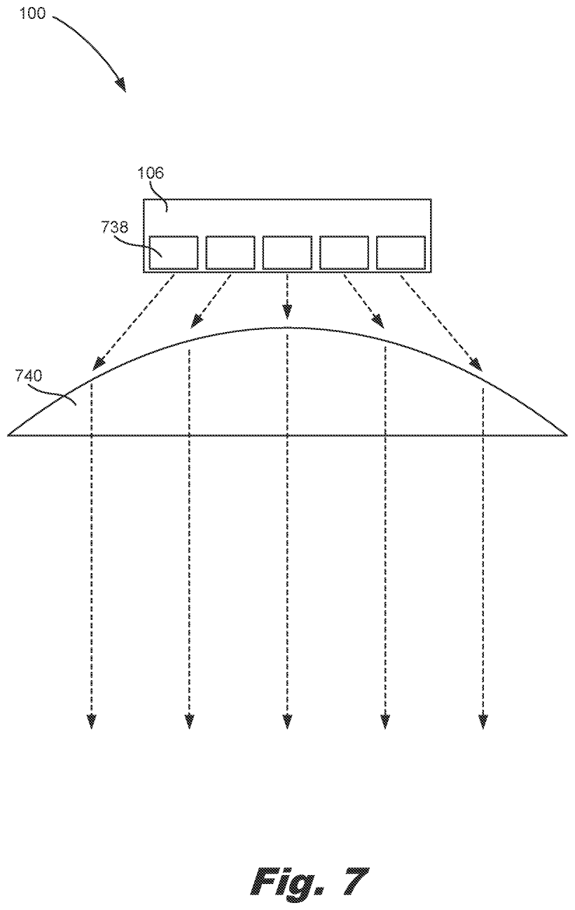

FIG. 7 is a front view of an additive manufacturing system (100) for generating a line-shaped energy beam (FIG. 3, 318), according to an example of the principles described herein. In this example, the energy delivery system (FIG. 1, 108) includes an array of light emitting diodes (LEDs) (738) to emit light. For simplicity in illustration, just one LED (738) in FIG. 7 is depicted with a reference number. In this example, LEDs (738) may be very long, i.e., in a direction, L, (324). Accordingly, the energy delivery system (FIG. 1, 108) may include a cylindrical lens (740) to focus the light into the line-shaped beam of energy (FIG. 3, 318).

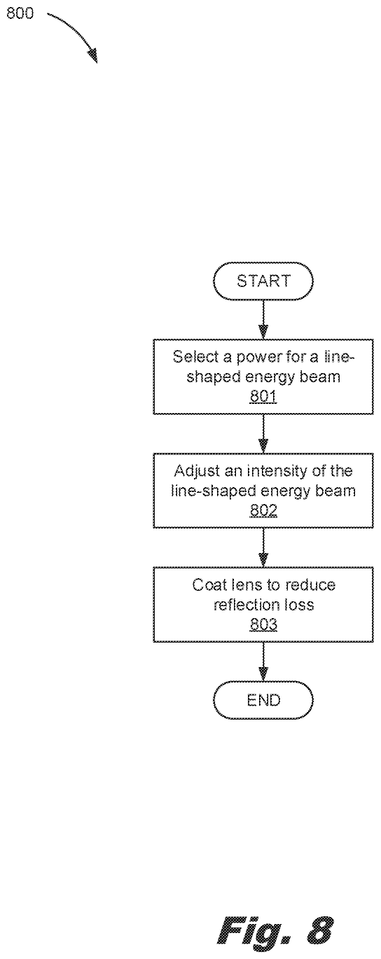

FIG. 8 is a flow chart of a method (800) for generating a line-shaped energy beam (FIG. 3, 318) during additive manufacturing, according to an example of the principles described herein. According to the method (800) a power for the line-shaped beam of energy (FIG. 3, 318) is selected (block 801). That is, as described above, a particular agent, i.e., binding agent or fusing agent, may have a particular fluence associated with it which identifies the amount of energy that is to be applied per unit area to ensure curing or fusing. Moreover, the length of the line-shaped energy beam (FIG. 3, 318) and a speed at which the scanning carriage (FIG. 1, 106) moves may also affect the exposure of the bed (FIG. 2, 210) to the energy source. Accordingly, a power for the line-shaped energy beam (FIG. 3, 318) may be selected (block 801) to ensure a desired curing or fusing reaction. This selection may be based on a number of factors such as a line-shaped energy beam (FIG. 3, 318) length (FIG. 3, 326) length, L, a carriage speed, v, and a target fluence value, which target fluence value may be a calculated amount to ensure adequate curing and/or fusing. In an example, the power may be selected (block 801) based on a composition of the build material. That is, characteristics of the build material and/or agent used may impact an absorption of energy. For example, some build materials may absorb more light energy such that an energy source with less power emission may be implemented.

In an example, the method (800) includes adjusting (block 802) at least one of an intensity of the line-shaped energy beam (FIG. 3, 318) and an exposure time. That is, for the same reasons as noted above, i.e., build material and/or agent properties, the amount of power to appropriately cure and/or fuse the build material may be different. Accordingly, the system may adjust (block 802) the intensity of the energy source such that a tailored curing/fusing is provided. That is, if too much energy is delivered, there may be excess heat loss and/or bleeding of the thermal energy to underlying layers which may impact object quality. By comparison, if not enough energy is delivered, the slice may not adequately cure or fuse.

Such adjustments may include adjusting a width of the line-shaped energy beam (FIG. 3, 318) or a power of the line-shaped energy beam (FIG. 3, 318). For example, as described above, a collimating lens (FIG. 5, 532) may be adjusted such that the beam output of the laser is more focused, which may reduce a width, (324) of the line-shaped energy beam (FIG. 3, 318).

The method (800) may also include coating (block 803) at least one of a collimating lens (FIG. 5, 532), and Powell lens (FIG. 5, 536) to reduce reflection loss. That is, there may be loses in optical energy as light travels through the lenses and other hardware components of the energy delivery system (FIG. 1, 100). For example, there may be reflective losses at either end of the fiber optic cable (FIG. 5, 530), the collimating lens (FIG. 5, 532), the mirror (FIG. 5, 534), and/or the Powell lens (FIG. 5, 536). Accordingly, coating any of these surfaces with an anti-reflection coating may reduce the reflective losses. As the laser (FIG. 3, 320) may have a single wavelength, or a smaller range than for example a halogen lamp or an LED, the coating may be more particularly tailored to a particular wavelength range of the laser, thus resulting in a better reflective efficiency. For example, a dielectric may be used for the anti-reflection coating. The thickness and dielectric constant of the coating can be tuned to match the single laser wavelength. Since the anti-reflection coating is tuned for the particular wavelength, anti-reflection can be greatly enhanced, which may withstand much higher optical power.

Accordingly, such systems and methods 1) provide a layer-by-layer curing of a binding agent; 2) provide energy sources that are energy efficient; 3) avoids use of a back reflecting mirror; 4) is compact; 5) reduces heat losses through conduction, convection, and radiation; 6) reduces the heating time such that the whole additive manufacturing operation is more efficient; and 7) Focuses the energy to reduce exposure time.

What is claimed is:

1. An additive manufacturing system, comprising:
a build material distributor to deposit layers of powder build material on a bed;
an agent distribution system to deposit an agent on a layer of powder build material in a pattem to form a slice of a three-dimensional object;
an energy delivery system to generate a line-shaped beam of energy to selectively join build material particles with the agent deposited thereon, wherein the line-shaped beam of energy spans a width of the bed; and
a scanning carriage to hold the energy delivery system and move the line-shaped beam of energy across the bed.

2. The additive manufacturing system of claim 1, wherein the energy delivery system comprises multiple energy-emitting elements.

3. The additive manufacturing system of claim 2, wherein:
each energy-emitting element is a laser; and
the energy delivery system further comprises, per laser:
a collimating lens connected via a fiber-optic cable to the laser; and
a Powell lens to fan out the energy beam to generate the line-shaped beam of energy across the bed.

4. The additive manufacturing system of claim 3, wherein:
the collimating lens and Powell lens are disposed on the scanning carriage; and
the laser is separated from the carriage.

5. The additive manufacturing system of claim 4, wherein:
the collimating lens is horizontal;
the Powell lens is vertical; and
the energy delivery system further comprises a mirror between the collimating lens and the Powell lens to alter an angle of the output of the laser.

6. The additive manufacturing system of claim 3, wherein:
the collimating lens is vertical; and
the Powell lens is vertical.

7. The additive manufacturing system of claim 1, wherein the energy delivery system comprises:
an array of light emitting diodes (LEDs) to emit light; and
a cylindrical lens to focus the light into the line-shaped beam of energy.

8. The additive manufacturing system of claim 1, wherein the scanning carriage is at least one of:
a build material distributor carriage;
an agent distribution system carriage; and
a carriage independent of the build material distributor carriage and the agent distribution system carriage.

9. A method, comprising:
depositing a layer of build material on a bed;
depositing an agent across the layer of build material in a pattern to form a slice of a three-dimensional object; and
scanning the line-shaped energy beam across the bed to selectively join build material particles with agent deposited thereon.

10. The method of claim 9, further comprising a selecting a power for the line-shaped energy beam based on at least one of:
an energy beam length;
a carriage speed;
a composition of the build material; and
a target fluence value.

11. The method of claim 9, further comprising adjusting at least one of an intensity of the line-shaped energy beam and an exposure time by adjusting at least one of:
a width of the line-shaped energy beam; and
a power of the line-shaped energy beam.

12. The method of claim 9, further comprising coating at least one of a collimating lens and Powell lens to reduce reflection loss.

13. An additive manufacturing system, comprising:
a build material distributor to deposit layers of powder build material on a bed;
an agent distribution system to deposit an agent on a layer of powder build material in a pattem to form a slice of a three-dimensional object;
an energy delivery system to selectively join build material particles with agent deposited thereon, the energy delivery system comprising:
an array of lasers;
a collimating lens per laser connected via a fiber-optic cable to a respective laser;
a Powell lens per collimating lens to alter a shape of an incoming circular energy beam to a line-shaped energy beam to span a width of the bed; and
a scanning carriage to traverse across the bed, wherein the collimating lens and Powell lens are disposed on the scanning carriage.

14. The additive manufacturing system of claim 13, wherein:
the agent is a binding agent; and
the energy delivery system is to cure the agent to remove solvent from a binding agent.

15. The additive manufacturing system of claim 13, wherein:
the agent is a fusing agent; and
the energy delivery system is to melt build material with the fusing agent deposited thereon.
